(19) United States
(12) Patent Application Publication
(10) Pub. No.: US 2006/0281365 A1
(43) Pub. Date: Dec. 14, 2006

(54) [ELECTRIC CONNECTING BLOCK FOR AV CONNECTOR]

(75) Inventor: Chen-Chih Huang, TAIPEI (TW)

Correspondence Address: LIH SHENG PRECISION INDUSTRIAL CO., LTD., P.O. BOX 108-00403, TAIPEI, TW

(73) Assignee: LIH SHENG PRECISION INDUSTRIAL CO., LTD., San Chung City, Taipei Hsien. (TW)

(21) Appl. No.: 11/160,206

(22) Filed: Jun. 14, 2005

(51) Int. Cl. H01R 13/66

(52) U.S. Cl. 439/541.5

(57) ABSTRACT

An electric connecting block for connecting two identical electric connectors together to form an AV connector is disclosed to include an electrically insulative block body with multiple terminal slots, and adapter terminals respectively mounted in the terminal slots for receiving connector terminals of one of the two electric connectors, each adapter terminal having a head with a retaining arm and a clamping arm positioned in one terminal slot for holding down one connector terminal of one of the two electric connectors and an terminal leg extending out of the bottom side of the block body for insertion through one insertion slot of the other of the two electric connectors.

### BACKGROUND OF THE INVENTION

1. Field of the Invention

The present invention relates to an AV (audio video) connector and more particularly, to an electric connecting block for connecting two identical electric connectors together to form an AV connector.

2. Description of the Related Art

Following the step of technology era, a variety of electronic and electric products have been continuously developed to improve our living quality, making our life more comfortable. Among these electronic and electric products, home electric appliances have a great concern with out daily life. These electric home appliances, including TV, stereo system, Video tape player and recorder, VCD/DVD player, and etc. help people to enjoy life and to relax the body and the mind. These electric and electronic commonly use an AV connector for transmitting audio and video signals. FIGS. 7 and 8 show a prior art AV connector for this purpose. This AV connector A comprises a first connector A1, which has first connector terminals A11, A12 mounted therein, and a second connector A2, which has second connector terminals A21, A22 mounted therein. The first connector terminals A11, A12 have the respective legs A111, A121 extending out of the bottom side of the first connector A1 and the second connector terminals A21, A22 have the respective legs A211, A221 extending out of the bottom side of the second connector A2. The first connector A1 has a plurality of insertion holes A13 corresponding to the first connector terminals A11, A12 at one side for the insertion of the legs A211, A221 of the second connector terminals A21, A22 of the second connector A2 to have the second connector A2 secured to the top side of the first connector A1. The second connector terminals A21, A22 have a respective bend A212, A222 that connects the respective leg A211, A221 to the respective second connector terminal A21, A22 so that the legs A211, A222 of the second connector terminals A21, A22 and the legs A111, A121 of the first connector terminals A11, A12 are kept in different directions after installation.

In actual practice, this design of AV connector A still has numerous drawbacks as follows.

1. The second connector terminals have a respective bend and a relatively longer leg than the first connector terminals. This design complicates the manufacturing of the AV connector.

2. The first connector and the second connector have different specifications, and different molds must be use to make these two connectors, complicating the manufacturing process.

Because the first connector and the second connector have different specifications, the inventory control is complicated.

3. The first connector and the second connector must be joined together before installation. When one connector failed, the whole assembly of the AV connector must be replaced.

### SUMMARY OF THE INVENTION

The present invention has been accomplished under the circumstances in view. It is therefore one object of the present invention to provide an electric connecting block for connecting two identical electric connectors together to form an AV connector. It is another object of the present invention to provide an electric connecting block for AV connector, which saves the manufacturing cost of the AV connector, and simplifies the AV connector inventory control. To achieve these and other objects of the present invention, the electric connecting block is adapted to connect two identical electric connectors together to form an AV connector. The electric connecting block comprises an electrically insulative block body, which has a plurality of terminal slot extending through the top and bottom sides thereof, and a plurality of adapter terminals respectively mounted in the terminal slots of the block body for receiving connector terminals of one of the two electric connectors. Each adapter terminal has a head positioned in one terminal slot of the block body for receiving one connector terminal of one of the two electric connectors, and an terminal leg extending out of the bottom side of the block body for insertion through one insertion slot of the other of the two electric connectors.

### BRIEF DESCRIPTION OF THE DRAWINGS

FIG. 1 is an elevational view of an electric connecting block according to the present invention.

FIG. 2 is an exploded view of the electric connecting block according to the present invention.

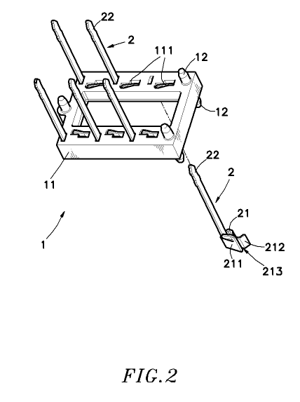

FIG. 3 is an elevational view of one adapter terminal for the electric connecting block according to the present invention.

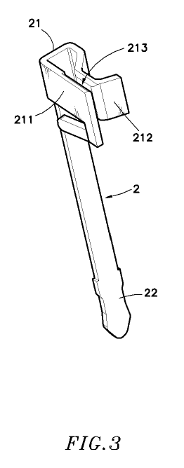

FIG. 4 is an elevational view of an AV connector constructed according to the present invention.

FIG. 5 is an exploded view of the AV connector shown in FIG. 4.

FIG. 6 is a sectional side plain view in an exploded status of the AV connector shown in FIG. 4.

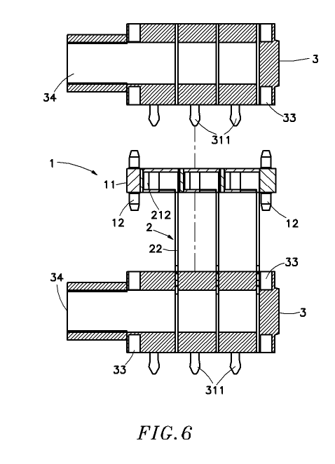

FIG. 7 is an elevational view of an AV connector according to the prior art.

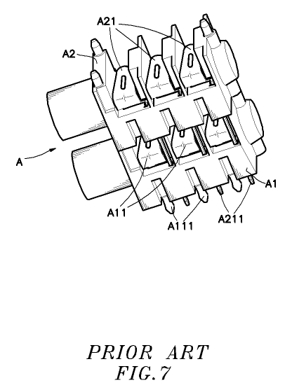

FIG. 8 is an exploded view of the prior art AV connector shown in FIG. 7.

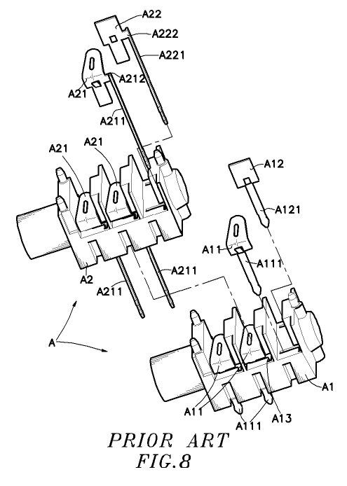

### DETAILED DESCRIPTION OF THE PREFERRED EMBODIMENT

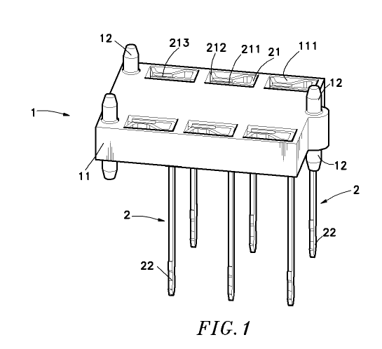

Referring to FIGS. 1˜3, an electric connecting block 1 in accordance with the present invention is shown comprising an electrically insulative block body 11 and a plurality of adapter terminals 2.

The electrically insulative block body 11 has a plurality of terminal slots 111 arranged in rows, and a plurality of positioning portions 12 respectively extended in reversed directions at two distal ends thereof.

The adapter terminals 2 each have a head 21, an terminal leg 22 extending from the bottom side of the head 21, a retaining arm 211 extending from one lateral side of the head 21 at right angles, and a clamping arm 212 extending from the other lateral side of the head 21 at right angles, and a receiving portion 213 defined in between the retaining arm 211 and the clamping arm 212.

During assembly procedure, the adapter terminals 2 are respectively inserted through the insertion slots 111 of the electrically insulative block body 11, keeping the head 21 and arms 211, 212 of each of the adapter terminals 2 positioned in the respective insertion slots 111 and the terminal leg 22 of each of the adapter terminals 2 suspending outside the electrically insulative block body 11.

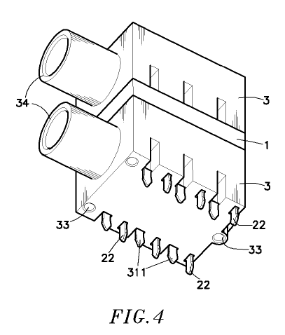

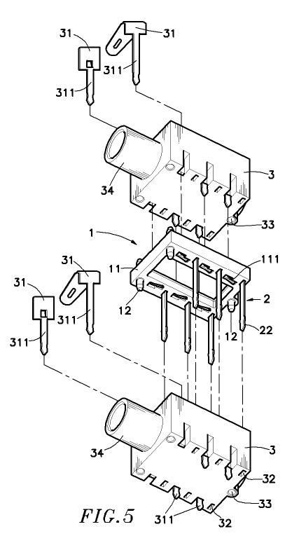

Referring to FIGS. 4 and 5, the electric connecting block 1 is adapted to connect two electric connectors 3 together, thereby forming an AV connector. The two electric connectors 3 are identical, each carrying a plurality of connector terminals 31. Each connector terminal 31 has an elongated leg 311 extending out of the bottom side of the respective electric connector 3. Further, each electric connector 3 has a plurality of insertion slots 32, a plurality of fastening portions 33, and a connecting portion 34 forwardly extending from one side, namely, the front side thereof for connection to a matching electric connector. During assembly process, the legs 311 of the connector terminals 31 of one of the two electric connectors 3 are respectively inserted into the terminal slots 111 of the electrically insulative block body 11 of the electric connecting block 1 and respectively engaged into the receiving portion 213 between the retaining arm 211 and clamping arm 212 of each of the adapter terminals 2, keeping the connector terminals 31 of the respective electric connector 3 respectively electrically connected to the respective adapter terminals 2 and the fastening portions 33 of the respective electric connector 3 respectively engaged with the positioning portions 12 at the top side of the electrically insulative block body 11 of the electric connecting block 1, and then the terminal legs 22 of the adapter terminals 2 of the electric connecting block 1 are respectively inserted through the insertion slots 32 of the second one of the two electric connectors 3 and extended out of the bottom side of the second one of the electric connectors 3 and at the same time the positioning portions 12 at the bottom side of the electrically insulative block body 11 of the electric connecting block 1 are respectively engaged into the fastening portions 33 of the second one of the electric connectors 3.

As an alternate form of the present invention, the positioning portions 12 of the electrically insulative block body 11 of the electric connecting block 1 can be positioning rods or positioning holes, and the fastening portions 33 of the electric connectors 3 can be fastening holes or fastening rods.

According to the aforesaid statement, the two electric connectors 3 are identical, and can be made with one single mold to reduce the manufacturing cost and to simplify the inventory control. When one electric connector 3 of the AV connector failed, the failed electric connector 3 can be detached from the AV connector for a replacement to save the cost.

As indicated above, the invention has the following advantages.

1. Because the two electric connectors of the AV connector have the same specification, the connector terminals of the two electric connectors are identical. Therefore, the connector terminals are easy and inexpensive to manufacture.

2. Because the two electric connectors have the same specification, they can easily be connected with the electric connecting block to form an AV connector, and the manufacturing of the two electric connectors is easy and inexpensive.

3. Because the two electric connectors have the same specification, the inventory control of the electric connectors is easy.

4. When one electric connector of the AV connector failed, the user needs only to buy a new electric connector for replacement without changing the whole unit of the AV connector.

A prototype of electric connecting block for AV connector has been constructed with the features of FIGS. 1˜6. The electric connecting block for AV connector functions smoothly to provide all of the features discussed earlier.

Although a particular embodiment of the invention has been described in detail for purposes of illustration, various modifications and enhancements may be made without departing from the spirit and scope of the invention.

What is claimed is:

1. An electric connecting block for connecting two identical electric connectors together to form an AV connector, the electric connecting block comprising a block body, said block body having a plurality of terminal slot extending through top and bottom sides thereof, and a plurality of adapter terminal respectively mounted in said insertion slots of said block body for receiving connector terminals of one of the two electric connectors to be used with the electric connecting block to form an AV connector, said adapter terminals each having a head positioned in one of said terminal slots of said block body and a terminal leg extending out of the bottom side of said block body.

2. The electric connecting block as claimed in claim 1, wherein said block body is electrically insulative, having a plurality of positioning portions at the top and bottom sides thereof for securing the two electric connectors to be used with the electric connecting block to form an AV connector.

3. The electric connecting block as claimed in claim 1, wherein said adapter terminals each have a retaining arm extending from a first lateral side of the head thereof at right angles, and a clamping arm extending from a second lateral side of the head thereof at right angles.

4. The electric connecting block as claimed in claim 3, wherein said adapter terminals each have a receiving portion defined in between the respective retaining arm and the respective clamping arm for holding one connector terminal of one of the two electric connectors to be used with the electric connecting block to form an AV connector.
